(19) United States
(12) Patent Application Publication
(10) Pub. No.: US 2010/0211249 A1
(43) Pub. Date: Aug. 19, 2010

(54) System and method for detecting vehicle maintenance requirements

(76) Inventor: Scott McClellan, Heber, UT (US)

Correspondence Address: STEPTOE & JOHNSON LLP, 1330 CONNECTICUT AVENUE, N.W., WASHINGTON, DC, 20036, US

(21) Appl. No.: 12/379,157

(22) Filed: Feb. 13, 2009

(51) Int. Cl. G06F 7/00

(52) U.S. Cl. 701/29

(57) ABSTRACT

System and method for monitoring the operation of a vehicle. A preferred embodiment comprises monitoring forces applied to the vehicle along one or more axes during operation of the vehicle, monitoring observed vehicle movement in response to the one or more forces, comparing the observed vehicle movement to a profile of expected vehicle movement, and identifying variations between the observed vehicle movement and the expected vehicle movement.

### TECHNICAL FIELD

The present invention relates generally to a system and method for monitoring the performance of a vehicle and, more particularly, to a system and method for detecting when a vehicle suspension, drive train, steering, or tires require maintenance.

### BACKGROUND

Typically, vehicle owners bring their automobiles, SUVs, or trucks to a dealer or repair shop when an obvious problem develops or for routine maintenance, such as an oil change. Maintenance issues that develop over a long period of time, such as suspension problems, can easily be overlooked by the average vehicle owner and, therefore, left uncorrected. However, these problems can cause severe damage and may require extensive and/or expensive repairs if the vehicle remains in use.

Vehicle suspensions consist of numerous components and generally include any components that support the vehicle's weight, such as springs, spring hangers, shocks, struts, ball joints, A-frames, kingpins, steering knuckles, spindles, and axles. Steering components, such as wheels, wheel bearings, hubs, tie rods, tie rod ends, idler arms, pitman arms, and control arms are attached to the suspension components and may also develop problems or failures over a period of time. Suspension, steering, and other maintenance problems may go unnoticed as they develop if a vehicle has multiple drivers, such as a fleet vehicle, or if the drivers have little vehicle maintenance experience.

Suspension and steering problems are usually identified by a driver while operating a vehicle or by a mechanic who inspects the vehicle. Shock or strut problems may be identified by pushing down on the vehicle and causing it to bounce. If the vehicle rebounds more than once, then it is likely that it has soft shocks or struts. Suspension problems may be indicated if the vehicle leans excessively while taking exit ramps or in high speed turns. Bad shocks and struts may also cause “cupping” of tires, in which one block of the tread stands out more than the next. Shock absorber problems may also be detected in the way a vehicle reacts to potholes or speed bumps. A worn shock allows the wheel to chatter on the road and can cause uneven wear on the tire. Spring fatigue may cause a vehicle to set lower than it did when new or to lean to one side.

Slack in the steering components, which might be felt as slack at the steering wheel, may also develop over time. Steering components, such as ball joints and tie rods should not move freely. They are designed to pivot tightly, and any play in either of these can be hazardous. When these parts go bad, a driver may feel a slight shimmy when turning under acceleration, or when steering through turns. This may cause misalignment, and uneven tire wear.

Tire and wheel imbalance or out-of-round may cause problems. A shimmy in the front end may be caused by a bent wheel, out of round tire, tire/wheel imbalance or other problems. Vibration may also result from tire balance problems. Uneven tire wear, such as outside edge wear, inside edge wear, high-low raised spots, or an uneven surface, may also indicate suspension problems and can cause vehicle vibrations. Alignment errors, which may be caused by suspension problems, may cause uneven wear on tires.

### SUMMARY OF THE INVENTION

These and other problems are generally solved or circumvented, and technical advantages are generally achieved, by preferred embodiments of the present invention in which a vehicle monitoring system detects abnormalities and potential problems in vehicle suspension, steering, and other components.

Embodiments of the present invention monitor vehicle performance and provide an early warning of possible or impending failure of suspension and steering components. A vehicle monitoring system monitors vehicle operation and detects trends that indicate maintenance issues. For example, if a driver must continually or often correct the drift of the vehicle to one side, the vehicle may have an alignment problem. If the vehicle oscillates excessively after hitting a bump or pothole, there may be a suspension problem.

A vehicle monitoring system may make a baseline measurement of the vehicle's performance that records operating parameters of the vehicle under normal operation. Alternatively, a generic set of operation parameters may be used for a particular make and model of vehicle. After establishing a baseline, a vehicle monitoring system may identify any deviation from those parameters. The vehicle monitoring system may identify statistical differences from normal operating conditions. If the vehicle indicates a change, such as a change in vertical movement, the vehicle monitoring system may detect a potential problem, such as an excessively bumpy road, low tire pressure, and/or bad shocks, struts or springs. The vehicle monitoring system may then notify the driver or other entity of potential maintenance issues.

In accordance with a preferred embodiment of the present invention, a method for monitoring the operation of a vehicle comprises monitoring forces applied to the vehicle along one or more axes during operation of the vehicle, monitoring observed vehicle movement in response to the one or more forces, comparing the observed vehicle movement to a profile of expected vehicle movement, and identifying variations between the observed vehicle movement and the expected vehicle movement. The forces may be monitored using a vehicle monitoring system installed in the vehicle. The vehicle monitoring system having at least one accelerometer for detecting the forces. The method may further comprise monitoring rotational forces about one or more of the axes during operation of the vehicle. The observed vehicle movement may be a vertical oscillation. Monitoring the observed vehicle movement step may further comprise monitoring an amplitude of the vertical oscillation, and monitoring a number of cycles of the vertical oscillation. Potential vehicle suspension problems may be identified based upon the vertical oscillation. The observed vehicle movement may also be a heading correction. The monitoring observed vehicle movement may further comprise detecting a number of heading corrections, and monitoring a frequency of the number of heading corrections. Potential vehicle alignment problems may be identified based upon the heading correction.

In another embodiment of the invention, a system and method for monitoring the operation of a vehicle comprises installing a vehicle monitoring system in the vehicle, the vehicle monitoring system comprising one or more sensors for detecting forces acting upon the vehicle and positioning and movement of the vehicle (e.g., accelerometers, angular sensors, yaw sensors, and the like), monitoring movement of the vehicle in response to forces acting upon the vehicle during a baseline period, establishing a baseline profile of the operation of the vehicle, the baseline profile comprising one or more ranges of vehicle movement along or about at least one axis, monitoring movement of the vehicle in response to forces acting upon the vehicle after the baseline period, and identifying deviations between the vehicle movement and the baseline profile after the baseline period. The movement may comprise both linear and rotational movement. The baseline profile may comprise data for more than one vehicle speed. The method may further comprise identifying vehicle maintenance requirements based upon the deviations from the baseline profile. The deviations may comprise vertical movement, such as one or more vehicle bounces, that exceed a vertical range in the baseline profile. The vertical movement is one or more vehicle bounces. The deviations may comprise rotational movement, such as a leaning of the vehicle during a turn that exceeds a rotation range in the baseline profile. The vertical and/or rotational movements may indicate a potential vehicle suspension problem.

In another embodiment, a system and method for identifying a vehicle maintenance problem comprises using a monitoring system installed in a vehicle to observe vertical oscillations of a vehicle, comparing the vertical oscillations to thresholds in a vehicle performance profile, identifying occurrences of vertical oscillations that exceed the thresholds, and using one or more of a number of oscillation cycles, a range of vertical oscillations, and a damping of the vertical oscillations to identify the vehicle maintenance problem. The vehicle maintenance problem may be a suspension problem.

In another embodiment, a system and method for identifying vehicle maintenance problem comprises using a monitoring system installed in a vehicle to observe rolling movement of the vehicle during turns, comparing the rolling movement to thresholds in a vehicle performance profile, identifying occurrences of rolling movement that exceed the thresholds, and identifying vehicle maintenance problems based upon the rolling movement that exceeds the thresholds. The vehicle maintenance problem may be a suspension problem.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a high-level block diagram of a vehicle monitoring system according to one embodiment;

FIG. 2 is a high-level block diagram of a system for detecting wireless device usage in moving vehicles;

FIGS. 3A-3C illustrate vehicle forces and vehicle movements that can be monitored in one embodiment of the invention;

FIG. 4 illustrates a vehicle monitoring system according to an embodiment of the invention; and

FIG. 5 is a flowchart illustrating a method for monitoring the operation of a vehicle according to one embodiment described herein.

### DETAILED DESCRIPTION

The present invention provides many applicable inventive concepts that can be embodied in a wide variety of specific contexts. The specific embodiments discussed are merely illustrative of specific ways to make and use the invention, and do not limit the scope of the invention.

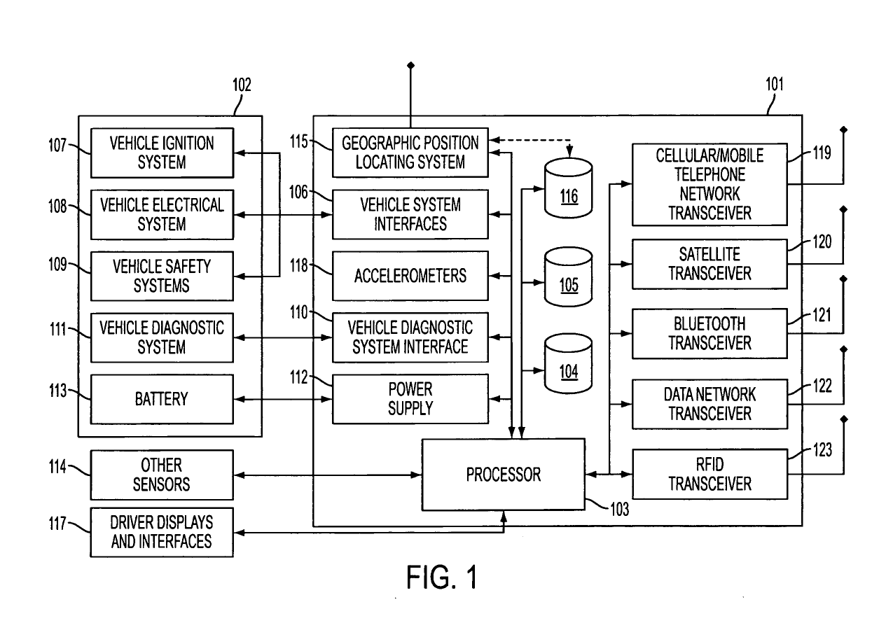

With reference to FIG. 1, there is shown vehicle monitoring system 101 that is coupled to one or more systems in vehicle 102. Vehicle monitoring system 101 may be configured to operate with any type of vehicle that travels in or on land, air and/or water, including, for example, automobiles, trucks, busses, motorcycles, boats, airplanes, or helicopters. Processor 103 controls the operation of monitoring system 101. Processor 103 may be a general use processing device having software designed to control system 101. Alternatively, processor 103 may be a specially designed circuit or device, such as an application specific integrate circuit (ASIC), that is particularly designed for use in system 101. Processor 103 may use firmware or software, such as an operating system, for control and operation. Firmware, software and other data may be stored in random access memory (RAM) 104, read only memory (ROM) 105, electrically erasable programmable memory (EEPROM) devices, or other storage devices, such as magnetic media or flash memory.

Monitoring system 101 includes one or more vehicle system interfaces 106 that allow system 101 to interact with systems in vehicle 102, such as vehicle ignition system 107, vehicle electrical system 108, and vehicle safety systems 109. Signals exchanged between interface 106 and vehicle ignition system 107 may allow monitoring system 101 to determine an operating status of vehicle 102 and, for example, to command the ignition system to start or shutdown the engine of vehicle 102. Signals exchanged between interface 106 and vehicle electrical system 108 may allow monitoring system 101 to determine a status of other vehicle systems and to command other systems to operate. For example, vehicle electrical system 108 may provide status and/or control of the vehicle's horn, interior and/or exterior lights, entertainment system, navigation system, heating and/or air conditioning systems, or alarm system. Signals exchanged between interface 106 and vehicle safety systems 109 may allow monitoring system 101 to determine a status of vehicle safety systems, to detect the use of the vehicle safety systems, and/or to control the operation of vehicle safety systems. For example, vehicle safety systems 109 may provide status and/or control information associated with a vehicle antilock brake system (ABS), traction control system, cruise control system, collision warning system, inter-vehicle distance warning system, vehicle proximity warning system, side object detection system, backup impact warning system, lane departure warning system, or drowsy driver detection and warning system and adaptive control systems such as adaptive cruise control.

Vehicle diagnostic system interface 110 provides a connection between monitoring system 101 and vehicle diagnostic system 111. Vehicle diagnostic system 111 may be an on-board diagnostic (OBD) II system or a controller area network (CAN) system in vehicle 102 that is accessed via a port or data bus. The OBD/CAN system provides access to engine performance and status data, speedometer, odometer and tachometer data, and data from other vehicle systems. Power supply 112 provides power to monitoring system 101. Power supply 112 may be a self-contained battery, for example, or it may be coupled to another power source, such as vehicle battery 113. There may be a direct connection between power supply 112 and vehicle battery 113, or power supply 112 may receive vehicle power via the vehicle's OBD/CAN bus, for example.

In addition to vehicle sensors and diagnostic systems, such as vehicle safety systems 109 and vehicle diagnostic system 111, monitoring system 101 may be coupled to other original equipment and aftermarket sensors in vehicle 102. For example, monitoring system 101 may be coupled to other sensors 114. For example, monitoring system 101 may be coupled an RF (radio frequency) transmission sensor, which is configured to detect transmissions such as cellular voice and data signals that originate from or are received at vehicle 102, such as the sensors described in U.S. patent application Ser. No. 11/866,247, entitled “System and Method for Detecting Use of a Wireless Device in a Moving Vehicle,” filed Oct. 2, 2007, the disclosure of which is hereby incorporated by reference herein in its entirety. Other sensors 114 may include, for example, seatbelt use sensors, alcohol or ethanol vapor sensors, trans-dermal ethanol sensors, cameras, microphones, accelerometers, crash detectors, or security system sensors.

Monitoring system 101 may include geographic position locating system 115 that identifies, generates or calculates location information associated with a current location of monitoring system 101 and vehicle 102 in which it is mounted. The location information may include latitude/longitude, street address, or map coordinates, for example. Geographic position locating system 115 may be, for example, a global positioning system (GPS) that receives location data from satellites via an antenna or may use radiolocation from a cellular network to determine the current location of monitoring system 101. Other navigation or location-determining systems may also be used, such as inertial navigation systems that update monitoring system 101 location as it moves from a known position, or terrestrial-based radio navigation systems, such as LORAN, TACAN or VOR. In other embodiments, geographic position locating system 115 may use transmissions or data from cellular or wireless network towers to determine a geographical location.

Vehicle monitoring system 101 may further include street mapping database 116 for use with geographic position locating system 115 and/or processor 103. For example, street mapping database 116 may include street maps for multiple locations and street data for specific streets, such as posted speed limits, lane number and direction, road conditions, and traffic conditions. The data in street mapping database 116 may be stored in a compact disc (CD), digital video disc (DVD), random access memory, read only memory, electrically erasable programmable memory, or other magnetic media or electronic storage. In other embodiments, street mapping database 116 may be stored in RAM 104 or ROM 105, or in geographic position locating system 115. In one embodiment, geographic position locating system 115 or processor 103 determine a current location of monitoring system 101 and vehicle 102 and use data from street mapping database 116 to display a map of the current location to the driver via displays and interfaces 117, such as the current street on which vehicle 102 is driving. Additional information may be presented to the driver, such as a street name, driving direction, posted speed limit, expected traffic conditions, or the like. Geographic position locating system 115 may also be used to calculate, determine and/or display routing information to a selected destination.

In one embodiment, the street mapping information stored in database 116 may be updated, for example, by the driver or a third party. The driver may enter data, such as updated traffic or construction information, updated posted speed limits, street names, or street closures, via driver interfaces 117. Alternatively, or additionally, monitoring device 101 may receive updated street mapping data, such as via a wireless transmissions received by one or more of transceivers 119-123, from a third party, such as monitoring service operator, street mapping data provider, fleet manager, or other person or entity.

Driver displays and interfaces 117 may be used to provide feedback to a driver and passengers in a vehicle. Processor 103 may be configured to identify alarm conditions, such as when vehicle 102 is operated outside of preselected conditions, and to provide feedback or alarms to the driver. Driver display and interface system 117 may be coupled to processor 103 and may include, for example, speakers, horns, warning lights, keypads, graphics, text or image display screens, or touch-screen displays. Upon detection of an alarm condition, processor 103 may command driver display and interface system 117 to present a warning to the driver, such as an alarm horn or audible tone or message via a speaker (not shown) or a visual warning via a warning light (not shown) or a tactile alert. Driver display and interface system 117 may also have the capability to provide text messages to a driver, for example, via a display screen (not shown). Driver display and interfaces 117 may comprise a number of individual components that are integral to monitoring system 101, integral to vehicle 102, and/or separate from monitoring system 101 and vehicle 102.

Vehicle monitoring system 101 may also include accelerometer module 118, which includes at least one accelerometer for measuring at least one of lateral (sideways), longitudinal (forward and aft) and vertical acceleration. Vehicle monitoring system 101 may use accelerometer module 118 to determine, for example, whether the driver is operating vehicle 102 in an unsafe or aggressive manner. High lateral acceleration measurements may indicate that the driver is operating vehicle 102 at an excessive speed in a turn. Excessive lateral acceleration, defined herein as “hard turns,” may be indicative of aggressive driving by the driver and may contribute to excessive wear on tires and steering components as well as potentially causing the load such as a trailer to shift and potentially overturn and/or damage the cargo being transported. Additionally or alternatively, accelerometers 118 may include a self-contained and tamper-resistant event data recorder or crash data recorder (CDR) similar to that which is shown and disclosed in U.S. Pat. Nos. 6,266,588 and 6,549,834 issued to McClellan et al., (the disclosures of which are hereby incorporated by reference herein in their entirety) and which is commercially known as “Witness” and commercially available from IWI, Inc. of Salt Lake City, Utah. Alternatively and/or additionally, sensors such as yaw sensors, inclinometers, angular sensors, and the like may be used. The CDR is adapted to continuously monitor vehicle motion and begin recording upon supra-threshold impacts whereupon it records the magnitude and direction of accelerations or G-forces experienced by the vehicle as well as recording an acceleration time-history of the impact event and velocity change between pre- and post-impact for a configurable duration following an impact. In one embodiment, the recordings are time-date stamped and are available to processor 103 for subsequent transmission to a supervisor or central monitoring facility if vehicle accelerations exceed an impulse threshold. Such accelerometers and CDRs are described in U.S. patent application Ser. No. 11/805,238, entitled “System and Method for Monitoring and Updating Speed-by-Street Data,” filed May 22, 2007, the disclosure of which is hereby incorporated by reference herein in its entirety.

Monitoring system 101 includes one or more systems that provide communications with other devices and systems. For example, monitoring system 101 may include cellular or mobile telephone transmitter/receiver 119 that allows system 101 to communicate with other devices and to send or receive data via a cellular or mobile network. Transceiver 119 may provide communications using any technology, protocol, standard or access method, such as, for example, 2G or 3G technologies known as Time Division Multiple Access (TDMA), Global System for Mobile communications (GSM), General Packet Radio Service (GPRS), Enhanced Data rates for GSM Evolution (EDGE), Enhanced GPRS (EGPRS), Code Division Multiple Access (CDMA), Wideband Code Division Multiple Access (W-CDMA), Universal Mobile Telecommunications System (UMTS), CDMA2000 1xRTT, CDMA2000 1xEV-DO, CDMA2000 1xEV-DV, or any other later developed communication technology.

Satellite transmitter/receiver 120 allows system 101 to communicate with other devices and to send or receive data via satellite network communications. Bluetooth transmitter/receiver 121 allows system 101 to communicate with other devices that have Bluetooth capability. Data network transmitter/receiver 122 allows system 101 to communicate via networks, such as data communication networks using WiFi, IEEE 802.11, WiMAX, or other standards or protocols, for example. Monitoring system 101 may also provide communications with other communication networks or systems via an RF, Infrared, or optical transmission system and/or sound based data transfer methods (e.g., ultrasound).

Monitoring system may also include RFID transceiver 123 operable to detect passive or active RFID tags or transponders in vehicle 102, for example, or within a certain distance of vehicle 102. The detection of certain RFID tags/transmitters, or the information received from the RFID tags/transmitters, may provide location information, vehicle information, driver or passenger information, or other nearby objects, products, or services.

Monitoring system 101 may further include one or more antennas to support communications for geographic position locating system 115, transceivers 119-122, and RFID transceiver 123. The antennas may be internal to monitoring system 101, may be formed as an integral part of a housing for system 101, or may be externally mounted on vehicle 102.

Although the connections between monitoring system 101 and the systems in vehicle 102, other sensors 114, and driver displays and interfaces 117 are illustrated as wireline connections, in other embodiments one or more of these connections may be wireless connections. For example, monitoring system 101 may communicate with, and exchange information with, vehicle safety systems 109, vehicle diagnostic system 111, other sensors 114, or driver displays and interfaces 117 via a Bluetooth connection, an infrared connection, or a IEEE 802.11 protocol communications link.

Driver performance may be measured using vehicle monitoring equipment, such as monitoring system 101, that is installed in a vehicle and collects information, such as the vehicle's speed, acceleration, and location. The system may capture data identifying where the vehicle is driven, when the vehicle is driven, and how the vehicle is driven (i.e. driver performance). One embodiment of a vehicle monitoring system is described in U.S. patent application Ser. No. 11/805,237, entitled “System and Method for Monitoring Vehicle Parameters and Driver Behavior,” filed May 22, 2007, the disclosure of which is incorporated by reference herein in its entirety. The vehicle monitoring system may receive inputs from internal and external sources and sensors such as accelerometers, geographic position locating systems, global positioning systems (GPS), vehicle on-board diagnostic systems, seatbelt sensors, wireless device, or cell phone use detectors, alcohol vapor detectors, or trans-dermal ethanol detection. The vehicle monitoring system may be used to evaluate and grade driver behavior, as described in U.S. patent application Ser. No. 11/755,556, filed on May 30, 2007, entitled “System and Method for Evaluating Driver Behavior,” the disclosure of which is hereby incorporated by reference herein in its entirety. The vehicle monitoring system may also be used to provide feedback and mentoring to the driver in order improve the driver's performance and driving behavior, such as described in U.S. patent application Ser. No. 11/768,056, filed on Jun. 25, 2007, entitled “System and Method for Monitoring and Improving Driver Behavior,” the disclosure of which is hereby incorporated by reference herein in its entirety.

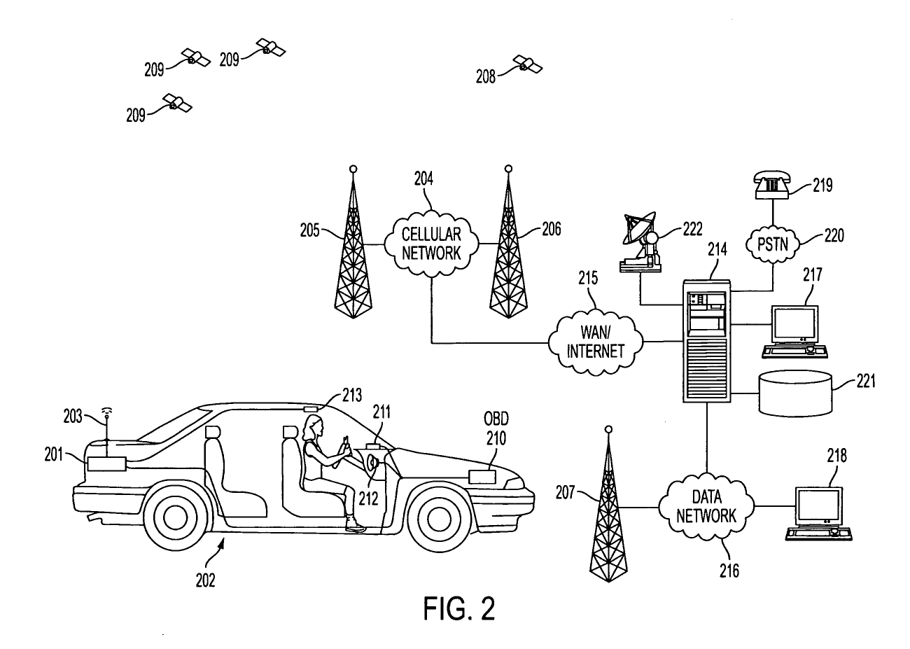

FIG. 2 illustrates monitoring system 201 installed or mounted in vehicle 202. Monitoring system 201 may be mounted in any location within vehicle 202, such as in a trunk, under a seat, in a glovebox, or on a window or dashboard. Although illustrated as a single box, vehicle monitoring system 201 may comprise one or more components installed in vehicle 202. Monitoring system 201 may be coupled to one or more antennas 203, which may be used to communicate with one or more satellite or terrestrial communications and/or navigation networks. Monitoring system 201 may be capable of communicating with one or more networks or systems, such as cellular or mobile telephone network 204, having base stations or cell sites 205 and 206, wireless data network 207, such as a Bluetooth, WiFi, WiMAX or 802.11 network, or communications satellite 208. Monitoring system may also be in communication with or receive signals from satellites 209, which may be part of a geographical position locating system, such as a GPS system.

Monitoring system 201 is coupled to and in data communication with on board diagnostic (OBD) system 210 in vehicle 202. OBD 210 provides monitoring system 201 with access to certain vehicle operating parameters including, but not limited to, vehicle speed such as via the speedometer, engine speed or throttle position such as via the tachometer, mileage such as via the odometer reading, seat belt status, condition of various vehicle systems including anti-lock-braking (ABS), turn signal, headlight, cruise control activation and a multitude of various other diagnostic parameters such as engine temperature, brake wear, and the like. Monitoring system 201 may also be coupled to driver feedback systems, such as warning lights or displays 211 and/or speaker 212.

Monitoring system 201 may also be coupled to detector and/or sensor 213 mounted in the passenger cabin of vehicle 202. Sensor 213 may be configured to detect any kind of activity, substance, or other information, such as seatbelt use sensors, alcohol or ethanol vapor sensors, trans-dermal ethanol sensors, cameras, microphones, accelerometers, crash detectors, or security system sensors. Other systems and equipment may be incorporated in vehicle 202. Vehicle monitoring system 201 may be coupled directly to these systems and equipment by wireline or wireless connection. Alternatively, vehicle monitoring system 201 may communicate indirectly with such systems and equipment, such as a cruise control system, via OBD 210 or other interface.

Server 214 may be any processor-based system that is capable of communicating with external networks and processing data associated with wireless device usage and vehicle monitoring systems. Server 214 may be coupled to multiple networks, such as cellular network 204 or wireless data network 207, via networks 215 and 216, which couple server 214 to other communication networks, may be any public or private data network, such as an Internet, intranet, extranet, or wide or local area network (WAN/LAN). Server 214 may be coupled to satellite 208 via antenna 222. In one embodiment, users may communicate with server 214 via a local or remote personal computer (PC), laptop computer, or terminal, such as devices 217 or 218. Alternatively, server 214 may communicate with users via a wireless device (not shown) or a wireline connection, such as telephone 219, using, for example, voice signals, an interactive voice response (IVR), a voice response unit (VRU), or dual tone multi-frequency (DTMF) tones. Telephone 219 may be coupled to public switched telephone network (PSTN) 220.

Memory 221 may be used to store information, such as user account data, vehicle data, vehicle monitoring system information, or street mapping data. Server 214 may access data stored on memory 221 and may store data to memory 221. Users may access memory 221, for example, to enter, update, or edit account data, via terminals or computers 217 and 218. Memory 221 may be internal or external to server 214 and may be located near to or remote from server 214. Communication between monitoring system 201 and server 214 may be via cellular network 204, data network 207 and/or communication satellite network 208 depending upon availability of each network, the urgency of the message, and/or user configuration.

Vehicle monitoring system 201 may transmit reports to server 214, such as vehicle operating conditions and parameters, vehicle system status, maintenance issues or requirements, and/or violations of operating requirements or limitations. Server 214 may then take action to record, report and/or mentor this behavior. For example, a user may configure server 214 to take certain action upon detecting that vehicle 202 requires maintenance. Server 214 may schedule a maintenance appointment for vehicle 202 and notify the driver of such appointment. Server 214 may command monitoring system 201 to broadcast warnings, such as audible messages or tones or visual lights or text, or tactile response to the driver of vehicle 202 to notify him of the need for maintenance. Additionally, server 214 may report the occurrence of a failed component or system or the need for maintenance to the vehicle's owner, supervisor, fleet manager or other authority.

The user may configure server 214 to send particular notices or feedback to vehicle 202 upon detection of problems with vehicle 202, such as the failure of certain components or systems or issues requiring vehicle maintenance. Such messages may notify the driver of the components at issue, type of maintenance required and/or direct the driver to discontinue using certain equipment. Server 214 may take further action as appropriate to warn or notify a supervisor, fleet manager, or otherwise document the event. Server 214 may also provide a report or notification to a supervisor or authority of the potentially unsafe driving conditions, such as by calling a fleet manager or parent via telephone 219 or by sending an email or text message to the supervisor.

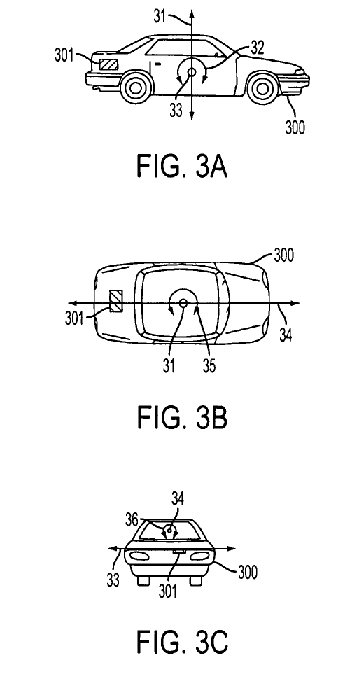

In some embodiments of the present invention, a vehicle monitoring system is configured to monitor the movement of a vehicle in at least six degrees of freedom using, for example, accelerometers 118 and/or geographic position locating system 115 (FIG. 1). The six degrees of freedom include linear motion along three orthogonal axes and rotational movement about the axes. FIG. 3A illustrates a side view of vehicle 300 having vehicle monitoring system 301 installed. Vehicle monitoring system 301 detects positive and negative vertical movement along z-axis 31 of vehicle 300 as well as rotational movement 32 (pitch) around y-axis 33. FIG. 3B illustrates a top view of vehicle 300. Vehicle monitoring system 301 detects forward and reverse lateral movement along x-axis 34 of vehicle 300 as well as rotational movement 35 (yaw) around z-axis 31. FIG. 3C illustrates a rear view of vehicle 300. Vehicle monitoring system 301 detects left and right lateral movement along y-axis 33 of vehicle 300 as well as rotational movement 36 (roll) around axis 34.

Vehicle 300 is expected to operate within certain parameters during normal use. For example, when passing over a bump, pothole, or other obstacle, vehicle 300 is expected to bounce along z-axis 31 within a certain range above and below its normal position and to damp out the oscillations within a certain time or number of cycles. In turns, vehicle 300 is expected to lean or roll 36 around x-axis 34. The amount of lean will depend upon the speed of vehicle 300 during the turn. During a stop or start, vehicle 300 may pitch down or pitch up, respectively, in direction 32 depending upon the speed of vehicle and the amount of braking or acceleration. The amount of The vehicle suspension, such as the springs, shocks and struts, control the response of vehicle 300 to such obstacles, turns, starts and stops. A vehicle performance profile may be created for vehicle 300 to define the normal or expected degrees of vertical movement, roll, or pitch in each of these and other situations. Additional parameters may be included to define the expected or normal lateral movement or yaw in other situations. A series of profiles may be established for a single vehicle to account for different operating conditions, such as different weights, loads, configurations, weather conditions, turn radius, road surfaces, road grade, or driver experience.

The vehicle performance profile may be stored in vehicle monitoring system 301, which may monitor the actual performance of vehicle 300 and identify when the movement of vehicle 300 exceeds the vehicle performance profile. For example, when traveling on level ground, vehicle 300 may be expected to lean between 3° and 8° in a turn at 30 MPH and between 7° and 13° at 60 MPH. If vehicle 300 actually leans 10° during a level 30 MPH turn, vehicle monitoring system 301 identifies a condition outside the expected vehicle performance profile. In the alternative where the suspension components are known to be in acceptable condition, the leaning outside of normal profile may be indicative of an unbalance and/or unsafe load. Monitoring the vehicle in the manner described may also be used to determine improper tire inflation. A “soggy” or uncharacteristic cornering response may also be a function of the tire inflation condition. Vehicle monitoring system 301 may be further configured to identify such a deviation outside the expected profile as a possible suspension failure, error or deterioration.

In one embodiment, vehicle monitoring system 301 simply identifies deviations outside the expected profile. In other embodiments, vehicle monitoring system 301 may also reference maintenance or error profiles that define expected vehicle performance when certain components have failed or deteriorated. For example, a suspension failure profile may be created to define the range of vehicle movement and rotation that is expected when the vehicle's suspension has failed. Such maintenance profiles may be generic for any suspension failure, or specific to certain problems such as shock or strut failures. Vehicle monitoring system 301 may compare vehicle 300's actual performance to the maintenance profiles to determine potential causes of the deviation from the expected profile. Vehicle monitoring system 301 may notify the driver, fleet manager, or a central server 214 (FIG. 2), for example, that vehicle 300 is operating outside the expected parameters and that such deviations are indicative of a suspension problem. Such additional monitoring of vehicle safety and suspension condition may also be used to qualify the vehicle and/or operator for insurance discounts as discussed in U.S. application Ser. No. ______ filed concurrently herewith and titled “SYSTEM AND METHOD FOR PROVIDING A USER INTERFACE FOR VEHICLE MENTORING SYSTEM USERS AND INSURERS” and U.S. application Ser. No. 11/779,178 filed Jul. 17, 2007 and titled “SYSTEM AND METHOD FOR CATEGORIZING DRIVING BEHAVIOR USING DRIVER MENTORING, AND/OR MONITORING EQUIPMENT TO DETERMINE UNDERWRITING RISK.”

The vehicle profiles may be based on different vehicle speeds, turn rates and/or turn radii. For each speed/rate/radius, an expected range of vehicle lean (i.e. roll) may be defined. If the vehicle leans or rolls more or less than expected, the vehicle monitoring system may identify a potential suspension or steering problem. The vehicle monitoring system may notify the driver or a vehicle owner/manager of the potential problem and recommend a maintenance check up. Alternatively, instead of listing expected degrees of lean or roll, the profile may define maximum allowed limits, so that observation of excess lean or roll indicates a potential suspension or steering problem.

Other profiles may also be used, such as a profile to identify potential shock or strut problems. A profile may define an expected damping response after a vehicle hits a pothole or other obstacle. The vehicle would be expected to bounce after hitting an obstacle, but the suspension should quickly eliminate the bouncing. A profile may define an expected and/or allowed range of bouncing, such as a number of inches above or below a normal position that the vehicle might be expected to move. The profile may also define the damping factor, such as an allowed number of oscillations. The damping factor may be defined as a first allowed bounce range on a first oscillation or cycle following the bump, a second allowed bounce range for the second oscillation or cycle after the bump, and so on. Vehicle response beyond the defined profiles would indicate potential suspension or steering problems and would be reported to the driver or third party.

A vehicle monitoring system may identify potential steering or alignment problems by observing constant or repeated steering inputs. If a vehicle alignment causes it to pull to the right, the driver will have to keep entering left steering inputs to keep the vehicle centered in its lane. These inputs may be detected by the vehicle monitoring system or an accelerometer as a series of lateral pulses. The vehicle monitoring system may report these lateral pulses as a possible steering component failure or vehicle misalignment, for example.

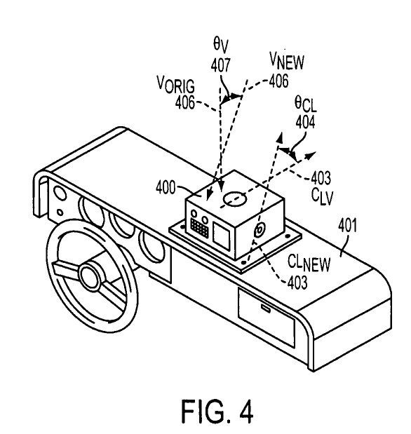

FIG. 4 illustrates one embodiment of a vehicle monitoring system 400 installed in a vehicle, such as the vehicle monitoring system disclosed in U.S. patent application Ser. No. 11/805,237, entitled “System and Method for Monitoring Vehicle Parameters and Driver Behavior.” As noted above, the vehicle monitoring system may be embodied as one or more components installed in any location in a vehicle. Vehicle monitoring system 400 is shown in FIG. 4 installed on dashboard 401 of a vehicle. As described in application Ser. No. 11/805,237, vehicle monitoring system 400 may be self-orienting to the centerline and vertical axes of a vehicle. Once vehicle monitoring system 400 is oriented to the vehicle's axes, any deviations or movements by the vehicle can be measured and used to evaluate suspension and steering problems.

Vehicle monitoring system 400 may be oriented to vehicle centerline CL_{V} 402, which may correspond to the normal forward direction of travel of the vehicle without turning. Any later deviation in the vehicle centerline would be detected by vehicle monitoring system 401. For example, if the vehicle's steering becomes misaligned, the centerline of the vehicle's travel may shift to CL_{NEW} 403. Vehicle monitoring system 400 may detect the shift from CL_{V} 402 to CL_{NEW} 403, which would a steering problem. The degree of shift θ_{CL} 404 from CL_{V} 402 to CL_{NEW} 403 may be measured by vehicle monitoring system 400 and may indicate the degree of misalignment.

In other embodiments, vehicle monitoring system 400 may be oriented to a vertical axis V_{ORIG} 405 of the vehicle, which may correspond to the normal z-axis when the vehicle is on level ground. Any later deviation in the vehicle's vertical axis would be detected by vehicle monitoring system 401. For example, if the vehicle's suspension fails and the vehicle leans to one side, the vehicle's vertical axis would shift to a new vector V_{NEW} 406. Vehicle monitoring system 400 may detect the shift from V_{ORIG} 405 to V_{NEW} 406 and identify a potential suspension problem. The degree of shift θ_{V} 407 from V_{ORIG} 405 to V_{NEW} 406 may be measured by vehicle monitoring system 400 and may indicate the type of suspension problem, such as a bad shock or strut or bad springs. Upon detecting a suspension problem, vehicle monitoring system 401 may report the problem to the driver or a vehicle owner and may recommend maintenance to be performed based upon the detected problem.

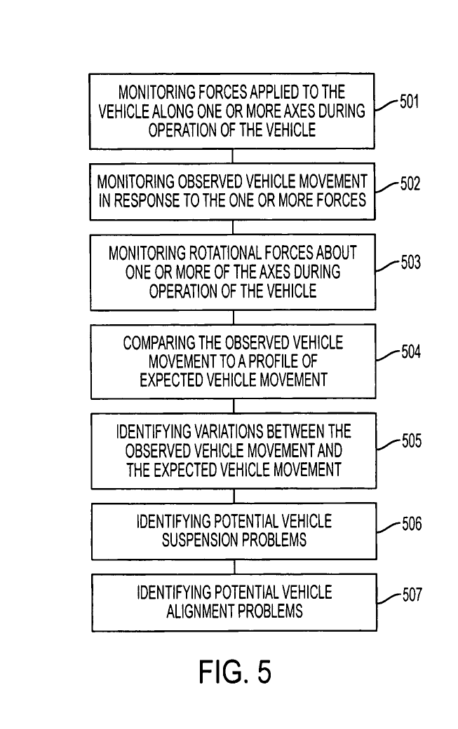

FIG. 5 illustrates a flowchart for an exemplary embodiment of a method for monitoring the operation of a vehicle. The method illustrated in FIG. 5 may be implemented, for example, using monitoring system 101 or 201, but is not intended to be limited to such a configuration. Moreover, it will be understood that the steps of the methods illustrated in FIG. 5 may be performed in the order indicated, or in any other order, or simultaneously, or in conjunction with other steps or methods. In step 501, forces applied to the vehicle along one or more axes are monitored during operation of the vehicle. The forces may be monitored using a vehicle monitoring system installed in the vehicle. The vehicle monitoring system may have one or more accelerometer for detecting the forces. In step 502, observed vehicle movement is monitored to determine the vehicle response to the one or more forces. The observed vehicle movement may be a vertical oscillation. The vehicle movement may include an amplitude of the vertical oscillation and a number of cycles of the vertical oscillation. The observed vehicle movement may be a heading correction. The observed vehicle movement may be a number of heading corrections and a frequency of the number of heading corrections. In step 503, rotational forces about one or more of the axes during operation of the vehicle are monitored.

In step 504, the observed vehicle movement is compared to a profile of expected vehicle movement. In step 505, variations between the observed vehicle movement and the expected vehicle movement are identified. In step 506, potential vehicle suspension problems are identified, such as suspension problems indicated by vertical oscillations. In step 506, potential vehicle alignment problems are identified, such as alignment problems indicated by heading corrections.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A vehicle monitoring device for performing a method of monitoring the operation of a vehicle, the method comprising:
monitoring one or more forces applied to a vehicle along one or more axes during operation of the vehicle;
monitoring observed vehicle movement in response to the one or more forces;
comparing the observed vehicle movement to a profile of expected vehicle movement; and
identifying variations between the observed vehicle movement and the expected vehicle movement.

2. The vehicle monitoring device of claim 1, wherein the forces are monitored using a vehicle monitoring system installed in the vehicle, the vehicle monitoring system having at least one accelerometer for detecting the forces.

3. The vehicle monitoring device of claim 1, wherein the method further comprises:
monitoring rotational forces about one or more of the axes during operation of the vehicle.

4. The vehicle monitoring device of claim 1, wherein the observed vehicle movement is a vertical oscillation.

5. The vehicle monitoring device of claim 1, wherein the monitoring observed vehicle movement step further comprises:
monitoring an amplitude of the vertical oscillation; and
monitoring a number of cycles of the vertical oscillation.

6. The vehicle monitoring device of claim 4, wherein the method further comprises:
identifying, based upon the vertical oscillation, one or more problems from the group consisting of potential vehicle suspension problems and potential vehicle tire problems.

7. The vehicle monitoring device of claim 1, wherein the observed vehicle movement is a heading correction.

8. The vehicle monitoring device of claim 7, wherein monitoring observed vehicle movement further comprises:
detecting a number of heading corrections; and
monitoring a frequency of the number of heading corrections.

9. The vehicle monitoring device of claim 4, wherein the method further comprises:
identifying potential vehicle alignment problems based upon a heading correction.

10. One or more computer-readable media having computer-usable instructions stored thereon for performing a method of monitoring the operation of a vehicle, the method comprising:
establishing a baseline profile of the operation of a vehicle, the baseline profile comprising one or more ranges of vehicle movement along or about at least one axis;
monitoring movement of the vehicle in response to forces acting upon the vehicle after a baseline period; and
identifying deviations between the vehicle movement and the baseline profile after the baseline period.

11. The media of claim 10, wherein the movement comprises both linear and rotational movement.

12. The media of claim 10, wherein the baseline profile comprises data for more than one vehicle speed.

13. The media of claim 10, wherein the method further comprises:
identifying vehicle maintenance requirements based upon the deviations from the baseline profile.

14. The media of claim 10, wherein the deviations comprise a vertical movement that exceeds a vertical range in the baseline profile.

15. The media of claim 14, wherein the vertical movement is one or more vehicle bounces.

16. The media of claim 10, wherein the deviations comprise a rotational movement that exceeds a rotation range in the baseline profile.

17. The media of claim 16, wherein the rotational movement is a leaning of the vehicle during a turn.

18. The media of claim 17, wherein the rotational movement indicates a potential vehicle suspension problem.

19. A method for identifying a vehicle maintenance problem, comprising:
observing, by a vehicle monitoring device, vertical oscillations of a vehicle;
comparing the vertical oscillations to thresholds in a vehicle performance profile;
identifying occurrences of vertical oscillations that exceed the thresholds; and
using one or more of a number of oscillation cycles, a range of vertical oscillations, and a damping of the vertical oscillations to identify the vehicle maintenance problem.

20. The method of claim 19, wherein the vehicle maintenance problems are suspension problems.

21. A method for identifying vehicle maintenance problems, comprising:
observing, by a vehicle monitoring device, rolling movement of a vehicle during turns;
comparing the rolling movement to thresholds in a vehicle performance profile;
identifying occurrences of rolling movement that exceed the thresholds; and
identifying vehicle maintenance problems based upon the rolling movement that exceeds the thresholds.

22. The method of claim 21, wherein the vehicle maintenance problems are suspension problems.

23. A driver alerting device comprising:
a vehicle monitoring device;
an output interface; and
a processor in communication with the vehicle monitoring device and the output interface, such that the processor is operable to obtain vehicle movement information in at least one direction in response to a force applied to the vehicle, to compare the vehicle movement information to a threshold, and to alert the driver when the vehicle acceleration information exceeds the threshold using the output interface.

24. The driver alerting device of claim 23, wherein the vehicle movement information is a vertical oscillation.

25. The driver alerting device of claim 24, wherein the processor is further operable to monitor an amplitude of the vertical oscillation and monitor a number of cycles of the vertical oscillation.

26. The driver alerting device of claim 24, wherein the processor is further operable to identify potential vehicle suspension problems based upon the vertical oscillation.

27. The driver alerting device of claim 24, wherein the process is further operable to identify potential vehicle tire problems based upon the vertical oscillation.

28. The driver alerting device of claim 23, wherein the vehicle movement is a heading correction.

29. The driver alerting device of claim 28, wherein the processor is further operable to detect a number of heading corrections and monitor a frequency of the number of heading corrections.

30. The driver alerting device of claim 28, wherein the processor is further operable to identify potential vehicle alignment problems based upon the heading correction.

31. The driver alerting device of claim 23, wherein the vehicle movement information is a rotational movement.

32. The driver alerting device of claim 31, wherein the rotational movement is a leaning of the vehicle during a turn.

33. The driver alerting device of claim 31, wherein the processor is further operable to identify potential vehicle suspension problems based upon the rotational movement.

34. The driver alerting device of claim 23, wherein the vehicle movement information is both linear and rotational movement.

35. The driver alerting device of claim 34, wherein the rotational movement is a leaning of the vehicle during a turn.

36. The driver alerting device of claim 34, wherein the processor is further operable to identify potential vehicle suspension problems based upon the rotational movement.
